(19) United States
(12) Patent Application Publication
(10) Pub. No.: US 2020/0205352 A1
(43) Pub. Date: Jul. 2, 2020

(54) TRELLIS APPARATUS FOR SUPPORTING A GROWING PLANT, AND RELATED SYSTEMS AND METHODS

(71) Applicants: Zachary David Riggs, Everett, WA (US); Nicholas Riggs, Everett, WA (US)

(72) Inventors: Zachary David Riggs, Everett, WA (US); Nicholas Riggs, Everett, WA (US)

(21) Appl. No.: 16/236,201

(22) Filed: Dec. 28, 2018

(51) Int. Cl. A01G 9/12; A01G 9/02

(52) U.S. Cl. CPC A01G 9/12; A01G 9/02

(57) ABSTRACT

A trellis apparatus for supporting a growing plant includes a mesh operable to support and hold a growing portion of a plant when the plant is held by a portable container, and a frame operable to support and hold the mesh above the plant when the plant is held by the portable container. The mesh is sized and configured to not support and not hold a growing portion of another plant when the other plant is not held by the portable container. The mesh includes an array of passages, each passage defined by a section of a line that is configured to form the mesh, and at least one of the passages is sized to allow a growing portion of the plant held by the portable container to extend through the passage. The frame includes a stanchion operable to position and hold the mesh above the plant when the plant is held by the portable container, and a coupler operable to secure the stanchion to the container that holds the growing plant.

### BACKGROUND

Many commercial and/or large gardens consist of a grow-area where multiple plants grow side by side. Sometimes the plants grown in this grow-area are arranged in rows that have a blank row between each of the plant rows so that gardeners can easily reach each individual plant to address any specific needs of the plant. For example, a gardener may have to thin-out a plant to promote the growth of other portions of the plant that the gardener wants to emphasize. For another example, the gardener may have to add medicine to a specific plant to address a disease that the plant has contracted, and/or a specific type or amount of fertilizer to a specific plant to help promote the growth of the plant, and/or physically remove unwanted insects from a specific plant to promote the growth of the plant and help prevent an infestation in neighboring plants.

Many commercial and/or large gardens also use a trellis to help support the plants grown in a grow-area and allow such plants to maximize their growth. Such trellis' typically involve spreading a single mesh across the whole grow-area. When a plant in the grow-area reaches a height where a portion of the mesh is positioned, the plant grows up through the mesh and may even grow around the material body of the mesh and become entangled with the mesh.

To more efficiently use the grow-area, many commercial and/or large gardens arrange their plants in a grow-area without any blank (or empty) rows, and thus eliminate the open space around each plant that a gardener can use to access each plant. When plants are grown in pots, arranging the pots in this manner does not often cause a significant problem because a gardener can easily move a pot to access an adjacent potted plant. Unfortunately, however, if the gardener also uses a trellis to help promote the growth of each of the many plants, and the plants have grown through or become entangled with the trellis, then the gardener has a very hard time reaching the plants growing in the interior of the grow-area. In such situations, the gardener has to either ignore the plants in the interior of the grow-area or has to contort his body into painful positions to reach and care for them. In addition, without the ability to easily move each potted plant in such a grow-area arrangement, the gardener can have a difficult time reaching equipment located above the interior of the grow-area, such as a sprinkler or a light, to repair or maintain such equipment.

Another problem with such arrangements of potted plants within a grow-area is that phenotyping can be difficult to perform. Phenotyping is a method of choosing the highest quality plant genetics from a large number of seeds. For example, a gardener may want to grow many seeds that all have shared parent genetics to find the best plant from that group of seeds. As each of these many seeds grow, each will display different dominant and recessive genetic traits. For example, some of the plants may be tall, some may be short, some may have thick branches, some may have thin branches, some may have many branches, and some may have few. The number of physical variations between phenotypes of the same parent genetics makes this process difficult to perform with a conventional trellis covering all of the plants in a grow-area.

Thus, there is a need for a system that supports a growing plant and allows one to easily access a growing plant located in the interior of a grow-area whose plants are arranged without a blank row to allow easy access to the interior of the grow-area.

### SUMMARY

In one aspect of the invention, a trellis for supporting a growing plant includes a mesh operable to support and hold a growing portion of a plant when the plant is held by a portable container, and a frame operable to support and hold the mesh above the plant when the plant is held by the portable container. The mesh is sized and configured to not support and not hold a growing portion of another plant when the other plant is not held by the portable container. The mesh includes an array of passages, each passage defined by a section of a line that is configured to form the mesh, and at least one of the passages is sized to allow a growing portion of the plant held by the portable container to extend through the passage. The frame includes a stanchion operable to position and hold the mesh above the plant when the plant is held by the portable container, and a coupler operable to secure the stanchion to the container that holds the growing plant.

With the trellis' mesh sized and configured to support only the plant held by the portable container that the trellis' stanchion is coupled with, the trellis does not support a plant growing in a portable pot that the trellis is not coupled with. This allows one to use a trellis to maximize the growth of many plants in a grow-area that are held by portable containers to more efficiently use the growing area. In such situations, one can move one or more portable containers to gain access to a plant located in the interior of the grow-area without having to untangle the one or more plants from a trellis that is not easily moved, or that supports a portion of plant that is not held by the portable container that is moved to gain access.

In another aspect of the invention, a method for supporting a growing plant includes: 1) disposing a plant in a portable container having a trellis coupled to the container, wherein the trellis includes a mesh and a frame. The trellis' mesh is sized and configured to not support and not hold a growing portion of a plant that is not held by the portable container, and includes an array of passages, each passage defined by a section of a line that is configured to form the mesh, and at least one of the passages is sized to allow a growing portion of the plant to extend through the passage. The trellis' frame includes a stanchion and a coupler. The method also includes: 2) with the frame's stanchion, positioning and holding the mesh near the plant in the portable container such that the mesh does not support and does not hold a plant disposed in another portable container; and 3) allowing a portion of the plant disposed in the portable container to grow through a passage of the trellis' mesh.

### BRIEF DESCRIPTION OF THE DRAWINGS

FIG. 1 shows a perspective view of a portable container and a trellis apparatus, each according to an embodiment of the invention.

FIG. 2A shows an exploded, partial, perspective view the portable container and a portion of the trellis apparatus shown in FIG. 1, according to an embodiment of the invention.

FIG. 2B shows a top view and a side view of a component of the portion of the trellis apparatus shown in FIG. 2A, according to an embodiment of the invention.

FIG. 3 shows a plan view of a different portion of the trellis apparatus shown in FIG. 1, according to an embodiment of the invention.

FIG. 4 shows a perspective view of a portable container and trellis apparatus, according to another embodiment of the invention.

### DETAILED DESCRIPTION

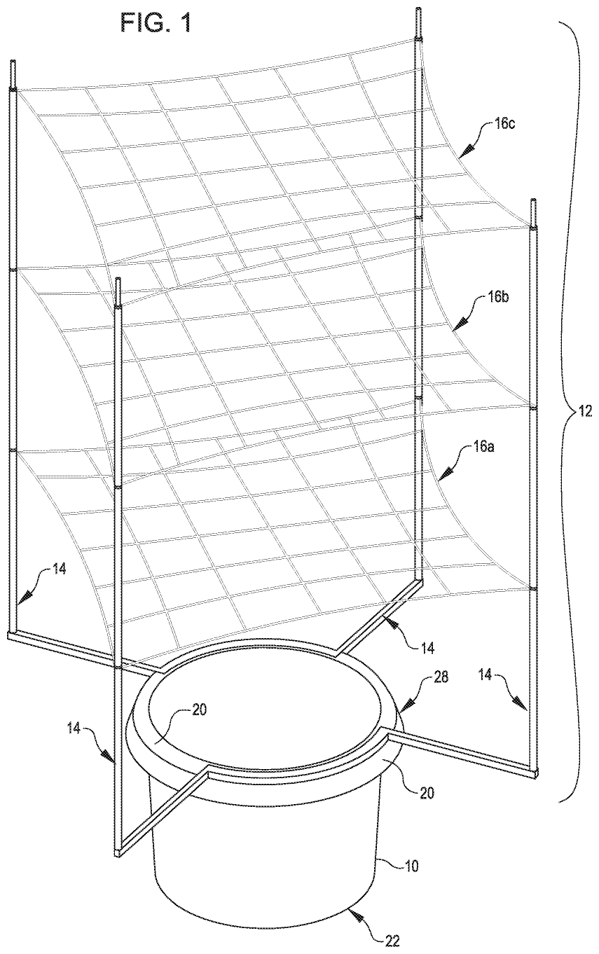

FIG. 1 shows a perspective view of a portable container 10 and a trellis apparatus 12, each according to an embodiment of the invention. The portable container 10 holds a plant (not shown) while the plant grows, and allows one to grow the plant at any location, including indoors if desired. The trellis apparatus 12 includes a frame 14 that is coupled to the portable container 10, and a mesh 16 that is sized and configured to only support the plant growing in the portable container that the trellis apparatus 12 is coupled to, not a plant growing in a portable container 10 adjacent to the portable container 10 that the trellis apparatus 12 is coupled with. The frame 14 supports and holds the mesh 16 above the plant while the plant grows in the container 10. As the plant reaches the mesh 16, the plant continues to grow through the mesh 16, which supports and holds the portion of the plant that the mesh 16 contacts.

Because the trellis' mesh 16 is sized and configured to support only the plant held by the portable container 10 that the trellis' frame 14 is coupled with, the trellis 12 does not support a plant growing in a portable container 10 that the trellis apparatus 12 is not coupled with. This allows one to use the trellis apparatus 12 to maximize the growth of the plant grown in the container 10, while placing many portable containers 10 with plants growing in each of them immediately adjacent their neighboring containers/plants in a grow-area to more efficiently use and manage the growing area. In such situations, one can move one or more portable containers 10 to gain access to a plant located in the interior of the grow-area without having to untangle the one or more plants from a trellis that is not easily moved, or that is coupled to a portable container 10 adjacent the container 10 being moved to gain access.

In this and other embodiments of the trellis apparatus 12, the frame 14 may support and hold a plurality of the meshes 16, each at any one of a variety of positions above the plant growing in the portable container 10. For example, in this embodiment the frame 14 supports and holds three meshes 16a, 16b, and 16c, each similarly configured to the other. The frame 14 supports and holds a first mesh 16a closest to the plant growing in the container, which becomes the first mesh that the plant grows through while it grows. The frame 14 also supports and holds a second mesh 16b above the first mesh 16a such that the second mesh 16b becomes the second mesh that the plant grows through while it grows. And finally, the frame 14 supports and holds a third mesh 16c above the second mesh 16b such that that the third mesh 16c becomes the third mesh that the plant grows through while it grows. In addition, the distance between each of the meshes 16a, 16b, and 16c is the same or substantially the same, the configuration of each of the meshes 16a, 16b, and 16c is the same or substantially the same, and the orientation of each of the meshes 16a, 16b, and 16c relative to the container 10 is the same or substantially the same—perpendicular to the direction that the plant grows in.

Other embodiments are possible. For example, the frame 14 may support and hold more or fewer meshes 16, each at a distance and/or angle different than what is shown in FIG. 1, and each in an orientation that is different than the other mesh or meshes 16. In addition, each of the meshes 16a, 16b, and 16c may also be configured differently than the other meshes 16a, 16b, and 16c.

With the trellis apparatus 12 modifiable into so many different configurations, one can easily phenotype for any desired plant genetics by providing a trellis designed to accommodate the specific physical traits expressed in a group of seeds, each grown in an individual portable container 10 located within a grow-area. Each plant grown can be individually cared for according to the specific traits that it expresses while it grows. This, in turn, increases operational efficiency of the grow-area, plant productivity and overall plant quality.

Still referring to FIG. 1, the portable container 10 may be configured as desired to accommodate a desired plant species and any number of the plants to be grown in the container 10. For example, in this and other embodiments the portable container 10 includes a plastic material and has a cylindrical shape whose top 18 is open and defined by a lip 20. The volume of the container 10 is 855.299 cubic inches, the diameter of the opening at the top 18 is eleven inches, and the distance between the bottom 22 and the opening is nine inches. In this example the container is configured to hold a single plant, which works well for growing a single, bushy plant. In other embodiments, the container may be configured to hold two or more plants while each of the plants grows.

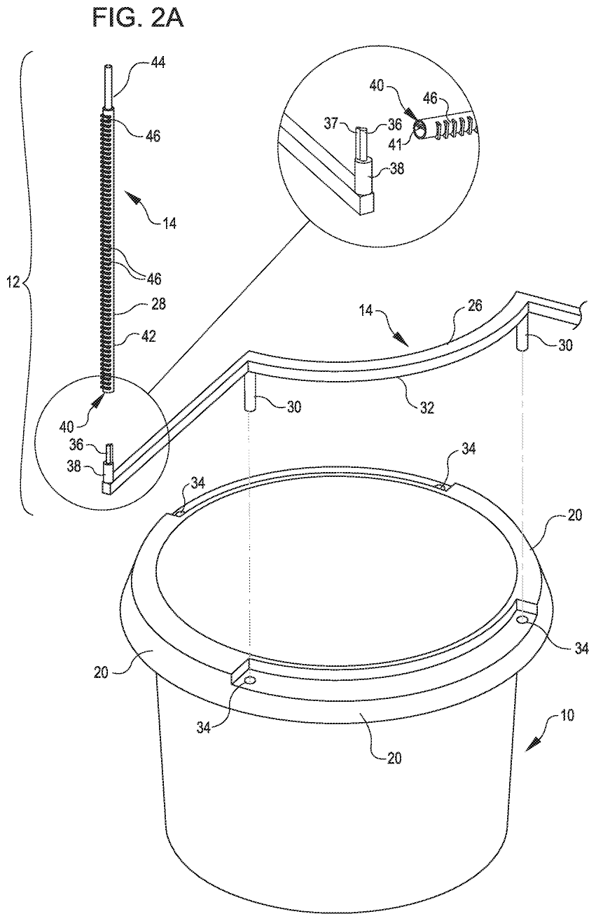

Still referring to FIG. 1, the trellis apparatus 12 may be coupled to the portable container 10 in any desired manner. For example, in this and other embodiments the trellis apparatus 12 is releasably coupled to the container's lip 20, as discussed in greater detail in conjunction with FIGS. 2A and 2B. This allows one to use the portable container without the trellis apparatus 12 if desired, and also allows one to use the trellis apparatus 12 on other portable containers 10 when desired. In other embodiments, the trellis apparatus 12 may not be releasably coupled with the portable container 10, but rather more permanently fixed to the container 10. In addition, other embodiments may include the trellis apparatus 12 coupled to other portions of or at other locations on the container 10.

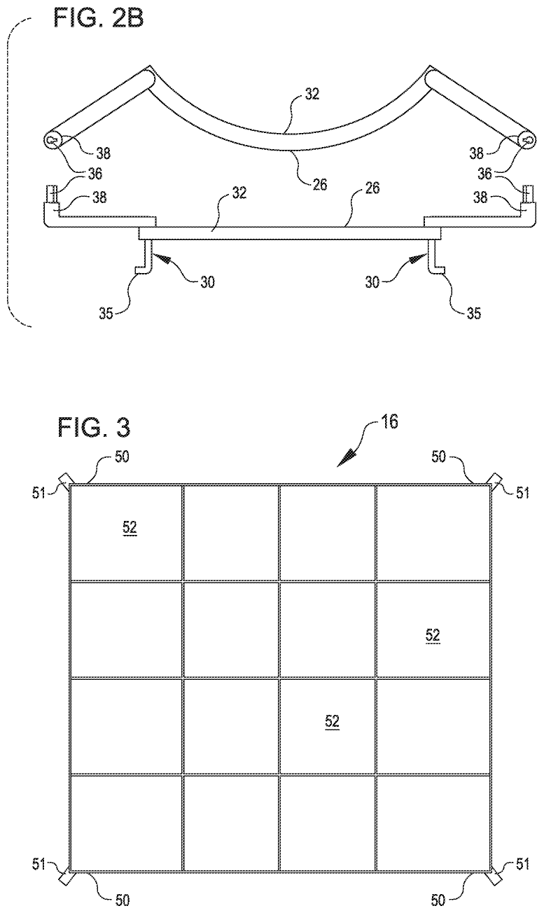

FIG. 2A shows an exploded, partial, perspective view of the portable container 10 and trellis apparatus 12 (mesh 16 omitted for clarity) shown in FIG. 1, according to an embodiment of the invention. FIG. 2B shows a top view and a side view of a component of the trellis apparatus 12 shown in FIG. 2A, according to an embodiment of the invention. The trellis apparatus 12 includes the frame 14 that supports and holds the mesh 16 (discussed in greater detail in conjunction with FIG. 3) above the plant while the plant grows in the container 10.

The frame 14 may be sized and configured as desired to support and hold the plant growing in the container 10 that it's coupled with while not supporting and holding a plant growing nearby. For example, in this and other embodiments the frame 14 includes a coupler 26 (FIGS. 2A and 2B) for releasably coupling the frame 14 with the container 10, and a stanchion 28 to position and hold the mesh 16 above the container 10 and thus a plant growing inside the container 10. Although four stanchions 28 are shown in FIG. 1 arranged to form a square above the container 10 with each stanchion 28 disposed at a corner of the square, FIG. 2A shows a single stanchion 28.

The coupler 26 releasably couples two stanchions 28 (only one shown in FIG. 1) to the container 10. The coupler 26 includes a first pin 30 (here two) that extends from a first end 32, and is sized to be inserted into and through a corresponding hole 34 (here four) in the container's lip 20. When coupled to the container's lip 20, the coupler's first pin 30 extends through the hole 34 about an inch and is simply urged to stay in the hole 34 by the weight of the frame 14. To help keep the first pin 30 extending through the hole 34 should a plant growing through the mesh urge the frame 14 away from the container 10, the first pin 30 includes a boss 35 (FIG. 2B) that extends substantially perpendicular to the direction that the pin 30 extends. The boss 35 helps prevent the first pin 30 from being withdrawn from the hole 34 by contacting the underside of the container's lip 20 when the plant urges the coupler 26 away from the container's lip 20. In other embodiments, the coupler 26 may include a mechanism, such as a latch that pivots relative to the first pin 30 or other part of the coupler 26 to engage a receiver on the container 10 or container's lip 20.

The coupler 26 also includes a second pin 36 that extends from a second end 38, and that is sized to be inserted into a receptacle 40 in the stanchion 28. The second pin 36 and the receptacle 40 are configured to hold the stanchion 28 in different clocked positions relative to the coupler 26. More specifically, the second pin 36 includes a rib 37, and the receptacle 40 includes a chord 41. When the second pin 36 is inserted into the receptacle 40, an edge of the rib 37 contacts the chord 41 and prevents the stanchion 28 from rotating relative to the coupler 26. In this embodiment, this configuration allows the stanchion 28 to be held in two different positions, each position clocked about 180 degrees relative to the other position.

The stanchion 28 may be sized and configured as desired. For example, in this and other embodiments the stanchion 28 includes a body 42 that is substantially straight and has a length of thirteen inches. The body 42 may be releasably coupled with another body 42 to increase the length of the stanchion 28 to accommodate plants of different heights. Although FIG. 2 shows one body 42 of a stanchion 28, FIG. 1 shows each of the four stanchions 28 comprised of three bodies 42 coupled in series to form a long stanchion 28. To allow the body 42 to be releasably coupled with another body 42, the body 42 includes a pin 44 that is sized and configured to be inserted into a receptacle (not shown) of another body 36 that is similar to the receptacle 40.

The body 42 also includes a series of grooves 46 (only three labeled for clarity) each sized and configured to hold a portion of the mesh 16 (FIG. 1). When the stanchion 28 holds a portion of the mesh, the body 42 is clocked to position the grooves 46 to open or face away from the center of the container 10. The mesh is then positioned above the container 10 with a portion of the mesh disposed in the groove 46 and extending around the outside portion of the body 42. To urge the portion of the mesh to remain inside the groove 46, tension is induced in the mesh's portion that lies in the groove 46.

Other embodiments are possible. For example, the frame 14 may include more or fewer than four stanchions 28, and the stanchions 28 may be arranged in a pattern other than a square, such as a triangle or a pentagon. For another example, the body 42 may be curved such that the body 42 extends over and toward the center of the container 10 as the body 42 extends up away from the container's lip 20. For yet another example. The body 42 may include other structures for releasably holding a portion of the mesh, such as a hook or carabiner, and/or for releasably holding other bodies 42.

FIG. 3 shows a plan view of a different portion of the trellis 12 apparatus (the mesh 16) shown in FIG. 1, according to an embodiment of the invention. The mesh 16 supports and holds the portion of the plant that the mesh 16 contacts and that is held by the container 10 (FIG. 1) that the mesh is coupled with and that the plant grows in, to maximize the growth of the plant; but the mesh 16 does not support and does not hold a growing portion of another plant when the other plant is not held by the portable container 10 that the mesh is coupled with.

The mesh 16 may be sized and configured as desired to support the plant growing in the container 10 that the mesh 16 is coupled with. For example, in this and other embodiments the mesh 16 includes a line comprising stretchable synthetic material woven into a string having a diameter of about 2 millimeters (mm). The string is then further woven or formed into a square mesh 16 that has a perimeter 50 that may be stretched around the stanchions 28 (FIG. 1). To facilitate stretching the perimeter 50 around a stanchion 28, the mesh 16 includes a tab 51 (here four) located at each corner of the mesh 16, that one can easily grab and grip to pull a portion of the perimeter 50 away from the center of the mesh 16. The mesh 16 also includes a plurality of passages 52 (sixteen shown but only three labeled for clarity) through which a portion of a plant can extend through when the plant reaches the location of the mesh 16 above the container 10 and continues to grow. The size of each passage 52 may be any size desired to match the type of plant growing in the container 10. For example, in this and other embodiments each of the passages is the same or substantially the same size and shape. More specifically, each passage is square and has an area of about sixteen square inches. This means that the total area of the mesh is about 256 square inches. This mesh size works well for a bushy plant that grows to a height of two to six feet.

Other embodiments are possible. For example, the line of the mesh 16 may be comprised of any desired material, such as any desired plastic or any desired metal. And, the shape, size and number of passages 52 in the mesh 16 may be any desired shape, such as circular, any desired size such as smaller than 16 square inches, and any desired number such as 32. For another example, the overall size and shape of the mesh 16 may be any desired shape, such as a circle, and any desired size, such as a circle whose radius is seven inches.

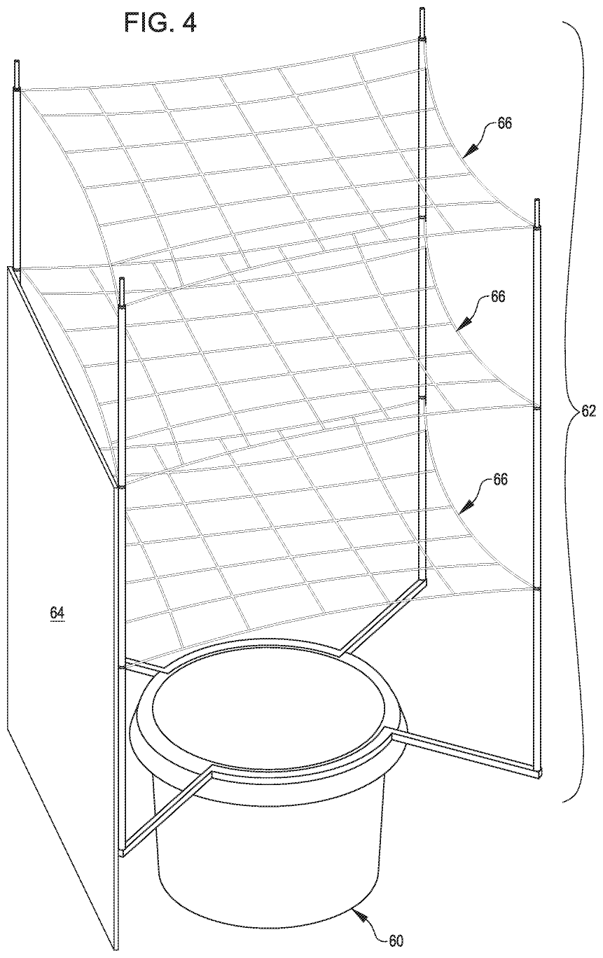

FIG. 4 shows a perspective view of a portable container 60 and trellis apparatus 62, according to another embodiment of the invention. The portable container 60 is similar to the portable container 10 shown in FIGS. 1 and 2A. The trellis apparatus 62 is also similar to the trellis apparatus 12 shown in FIGS. 1-3, except that the trellis apparatus 62 includes a skirt 64 that acts as a barrier to the plant growing in the container 60, and/or to a plant growing in an adjacent container that the trellis apparatus 62 is not coupled with. In this manner, the skirt 64 helps keep the mesh 66 from supporting and holding a plant growing in an adjacent container that the trellis apparatus 62 is not coupled with. The skirt 64 may be located anywhere on the trellis apparatus 62 and may cover all or a portion of the trellis apparatus 62, as shown in FIG. 4. The skirt 64 may also include a mesh whose passages are smaller than the size of the plant portions that attempt to grow through the skirt 64, and thus prevent the plant from extending through the skirt. The skirt 64 may also include a solid sheet of material.

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A trellis apparatus for supporting a growing plant, the trellis comprising:
a mesh operable to support and hold a growing portion of a plant when the plant is held by a portable container, wherein:
the mesh is sized and configured to not support and not hold a growing portion of another plant when the other plant is not held by the portable container, and
the mesh has an array of passages, each passage defined by a section of a line that is configured to form the mesh, and at least one of the passages is sized to allow a growing portion of the plant held by the portable container to extend through the passage; and
a frame operable to support and hold the mesh above the plant when the plant is held by the portable container, wherein the frame includes:
a stanchion operable to position and hold the mesh above the plant when the plant is held by the portable container, and
a coupler operable to secure the stanchion to the container.

2. The trellis apparatus of claim 1 wherein the mesh is sized and configured to support and hold a growing portion of two or more plants, when the two or more plants are held in the portable container.

3. The trellis apparatus of claim 1 wherein the line of the mesh includes string.

4. The trellis apparatus of claim 1 wherein at least one of the passages is square-shaped and has a cross-sectional area of about sixteen square inches.

5. The trellis apparatus of claim 1 wherein the mesh is square shaped and has an area of about 256 square inches.

6. The trellis apparatus of claim 1 wherein the mesh includes:
a first mesh located a first distance above the plant, when the plant is held by the portable container, and
a second mesh located a second distance above the plant, when the plant is held by the portable container, the second distance being farther away from the plant than the first distance.

7. The trellis apparatus of claim 1 wherein the frame includes four stanchions.

8. The trellis apparatus of claim 1 wherein the frame's coupler is configured to releasably couple the stanchion to an edge of a container.

9. The trellis apparatus of claim 1 wherein the stanchion includes a notch sized to receive and hold a line of the trellis' mesh to support and hold the mesh above the plant when the plant is held by a portable container.

10. The trellis apparatus of claim 1 wherein the stanchion includes a series of notches each sized to receive and hold a line of the trellis' mesh to support and hold the mesh above the plant at a position that is different than each of the positions associated with a respective one of each of the other notches.

11. The trellis apparatus of claim 1 wherein the stanchion has a length that is adjustable.

12. A system for growing a plant, the system comprising:
a portable container to hold a plant while the plant grows; and
a trellis apparatus to support the plant while the plant grows, the trellis apparatus comprising:
a mesh operable to support and hold a growing portion of the plant, wherein:
the mesh is sized and configured to not support and not hold a growing portion of another plant that is not held by the portable container, and
the mesh has an array of passages, each passage defined by a section of a line that is configured to form the mesh, and at least one of the passages is sized to allow a growing portion of the plant to extend through the passage; and
a frame that supports and holds the mesh above the plant, wherein the frame includes:
a stanchion that positions and holds the mesh above the plant, and
a coupler that secures the stanchion to the container.

13. The system of claim 12 wherein the portable container is operable to hold two or more plants while each plant grows.

14. The system of claim 12 wherein the frame's coupler is releasably secured to the portable container.

15. The system of claim 12 wherein the frame's coupler is releasably secured to a top lip of the portable container.

16. The system of claim 12 wherein the frame's coupler is permanently secured to the portable container.

17. A method for growing a plant, the method comprising:
disposing a plant in a portable container having a trellis apparatus coupled to the container, wherein the trellis apparatus includes:
a mesh that is sized and configured to not support and not hold a growing portion of a plant that is not held by the portable container, and that includes an array of passages, each passage defined by a section of a line that is configured to form the mesh, and at least one of the passages is sized to allow a growing portion of the plant to extend through the passage, and
a frame that includes a stanchion and a coupler;
with the frame's stanchion, positioning and holding the mesh near the plant in the portable container such that the mesh does not support and does not hold a plant disposed in another portable container;
allowing a portion of the plant disposed in the portable container to grow through a passage of the trellis apparatus' mesh; and
with the trellis apparatus' mesh, supporting and holding the plant.

18. The method of claim 17 wherein disposing a plant in a portable container includes disposing more than one plant in the portable container.

19. The method of claim 17 wherein positioning and holding the mesh near the plant in the portable container includes moving the mesh to another position near the plant.

20. The method of claim 19 wherein moving the mesh to another position near the plant includes separating the mesh from the frame's stanchion and re-attaching the mesh to a different location on the frame's stanchion.

21. The method of claim 19 wherein moving the mesh to another position near the plant includes moving a portion of the stanchion relative to the portable container.

22. The method of claim 17 further comprising uncoupling the trellis apparatus from the portable container.
